(19) United States
(12) Patent Application Publication
(10) Pub. No.: US 2016/0227099 A1
(43) Pub. Date: Aug. 4, 2016

(54) SHORT WAVE INFRARED CAMERA

(71) Applicant: Hamilton Sundstrand Corporation, Charlotte, NC (US)

(72) Inventors: Marc Hansen, Hamilton, NJ (US); Adityanand Girdhari, Franklin Park, NJ (US)

(21) Appl. No.: 14/612,915

(22) Filed: Feb. 3, 2015

(51) Int. Cl. H04N 5/232; G03B 13/04; H04N 5/225; H04N 5/33

(52) U.S. Cl. CPC H04N 5/23209; H04N 5/23293; H04N 5/33; G03B 13/04; H04N 5/2253

(57) ABSTRACT

An exemplary camera assembly includes a camera body, a camera lens, a cradle that communicates signals between the camera body and the camera lens, and a short wave infrared sensor module selectively received within the cradle.

### BACKGROUND

Short wave infrared cameras are useful to, among other things, identify objects through atmospheric obscurants. Many vision technologies Have difficulty seeing images clearly in low light. Short wave infrared cameras can clarify images in low light. That is, images captured with short wave infrared cameras have reduced degradation associated with bright lights and flashes verses many other types of image capturing technologies.

Thermal cameras can also clarify images in low light conditions, but thermal cameras cannot image through glass. Short wave infrared cameras can image through glass.

Some known standard cameras are converted to capture short wave infrared images by attaching a camera body directly to one end of the short wave infrared portion and a camera lens directly to an opposing end of the short wave infrared portion. Such systems are not conducive to swapping out a short wave infrared portion when short wave infrared imaging is no longer desired.

Cradles have been developed that accommodate camera modules, but these known cradles cannot accommodate short wave infrared modules.

### SUMMARY

A camera assembly according to an exemplary aspect of the present disclosure includes, among other things, a camera body, a camera lens, a cradle that communicates signals between the camera body and the camera lens, and a short wave infrared sensor module selectively received within the cradle.

In a further non-limiting embodiment of the foregoing assembly, the assembly includes a display to display an image received by the short wave infrared sensor module.

In a further non-limiting embodiment of any of the foregoing assemblies, the camera body comprises the display.

In a further non-limiting embodiment of any of the foregoing assemblies, the display is a first display, and the short wave infrared sensor module comprises a second display to display an image received by the short wave infrared sensor module.

In a further non-limiting embodiment of any of the foregoing assemblies, the assembly includes a relay optic within the short wave infrared sensor module.

In a further non-limiting embodiment of any of the foregoing assemblies, the cradle selectively receives other modules.

In a further non-limiting embodiment of any of the foregoing assemblies, the assembly includes an optical relay within the short wave infrared sensor module. The optical relay magnifies an image captured by the short wave infrared sensor module over a fixed distance between an organic light emitting diode display of the camera body and a sensor of the camera body.

In a further non-limiting embodiment of any of the foregoing assemblies, the short wave infrared sensor module communicates with camera body and the camera lens through the cradle.

In a further non-limiting embodiment of any of the foregoing assemblies, the camera body and the camera lens are commercial off-the-shelf components.

A method of short wave infrared sensor module imaging according to an exemplary aspect of the present disclosure includes, among other things, communicating signals from a camera body through a cradle to control a camera lens, and selectively receiving a short wave infrared sensor module within the cradle.

In a further non-limiting embodiment of the foregoing method, the method includes displaying a short wave infrared sensor image on the short wave infrared sensor module.

In a further non-limiting embodiment of any of the foregoing methods, the method includes displaying an image from the short wave infrared sensor module on the camera body.

In a further non-limiting embodiment of any of the foregoing methods, the method includes selectively replacing the short wave infrared sensor module within the cradle with another type of imaging module.

In a further non-limiting embodiment of any of the foregoing methods, the camera body and camera lens are commercial off-the-shelf components.

### DESCRIPTION OF THE FIGURES

The various features and advantages of the disclosed examples will become apparent to those skilled in the art from the detailed description. The figures that accompany the detailed description can be briefly described as follows:

FIG. 1 shows a highly schematic view of an example camera assembly.

FIG. 2 shows a perspective view of another camera assembly.

FIG. 3 shows a cradle of the camera assembly of FIG. 2.

FIG. 4 shows a short wave infrared sensor module from the camera assembly of FIG. 2.

### DETAILED DESCRIPTION

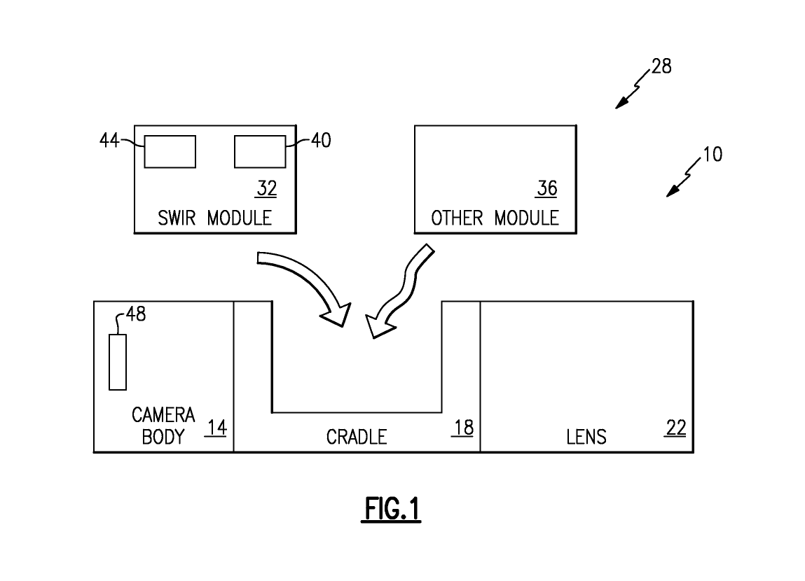

Referring to FIG. 1, an example camera assembly 10 includes a camera body 14, a cradle 18, and a camera lens 22. The camera body 14 controls the camera lens 22 through the cradle 18. The camera body 14 may adjust the camera lens 22 to bring objects into focus, for example. Signals thus communicate between the camera body 14 and the camera lens 22 through the cradle 18.

The cradle 18 selectively receives one of a plurality of imaging modules 28. At least one of the modules is a short wave infrared sensor (“SWIR”) module 32. In contrast to the SWIR module 32, the module 36 is not a short wave infrared sensor module. Instead, the SWIR module 32 is another type of imaging module. For example, the module 36 may be a module comprising intensifier tubes or a module comprising a complementary metal oxide silicon sensor.

SWIR images are generally obtained from wavelengths within the infrared band that are from 1.4 to 3 micrometers. Positioning the SWIR module 32 within the cradle 18 converts the camera assembly 10 to a SWIR imager that is capable of capturing SWIR images.

When the SWIR module 32 is installed within the cradle 18, the SWIR module 32 receives SWIR wavelengths through the camera lens 22. The wavelengths land on a focal point of a sensor within the SWIR module 32. Notably, a first portion of the cradle 18 is positioned axially between the camera body 14 and the SWIR module 32, and a second portion of the cradle 18 is positioned axially between the SWIR module 32 and the camera lens 22.

The example SWIR module 32 displays an image on a visual display 40 within the SWIR module 32. The image is based on the wavelengths sensed by the sensor within the SWIR module 32.

The SWIR module 32 further includes a relay optic 44 that sends a signal through the cradle 18 to the camera body 14 to enable the camera body 14 to reimage the wavelengths sensed by the sensor onto a sensor of the camera body 14. The camera body 14 may include a display 48 to provide a visual representation of an image based on the reimaged wavelengths from the sensor of the camera body 14.

The SWIR module 32 can include an eyepiece to allow for direct viewing of the SWIR imagery. The SWIR module 32 can further include an output to send analog video of the SWIR imagery that a user can then view or record.

The modularity of the camera assembly 10 provides the camera body 14 with the ability to obtain SWIR imagery via relatively few connections.

When obtaining SWIR imagery is no longer desired, the SWIR module 32 can be removed from the cradle 18 and replaced with the module 36. Disconnecting the camera body 14 from the cradle 58 is not required when swapping the SWIR module 32 for the module 36. Disconnecting the camera lens 22 from the cradle 58 is not required when swapping the SWIR module 32 for the module 36.

When converted to a SWIR imager, the camera assembly 10 has an enhanced ability to view images through haze, smoke, and dust. Military and security operators may utilize SWIR imaging during intelligence, surveillance, and reconnaissance activities.

When converted to a SWIR imager, the camera assembly 10 can recognize SWIR markers and beacons, as well as provide an operator of the camera assembly 10 with enhanced battlefield laser awareness.

When converted to a SWIR imager, the camera assembly can obtain imagery through glass and images are not substantially influenced by lights and flashes.

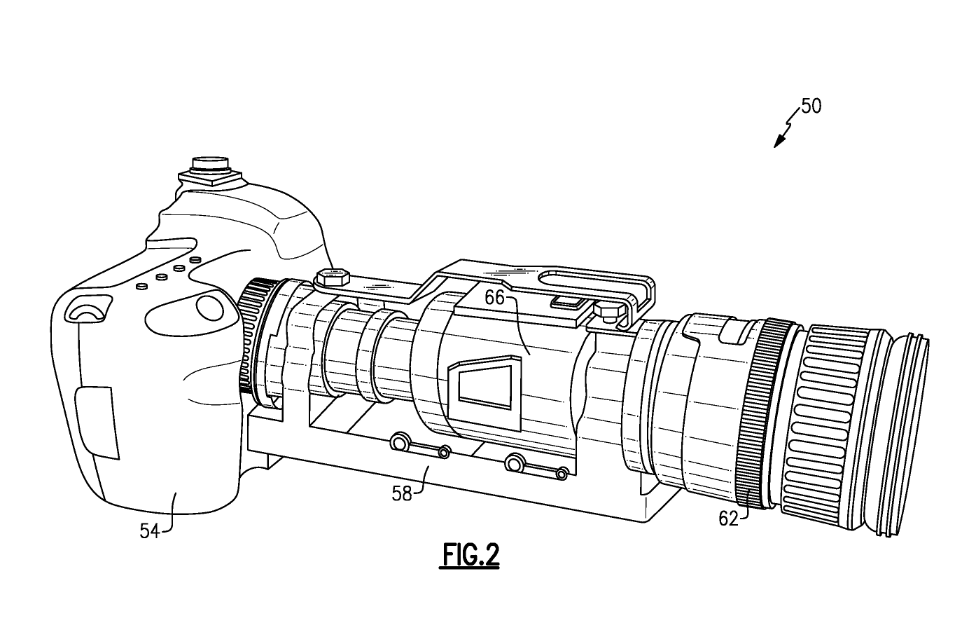

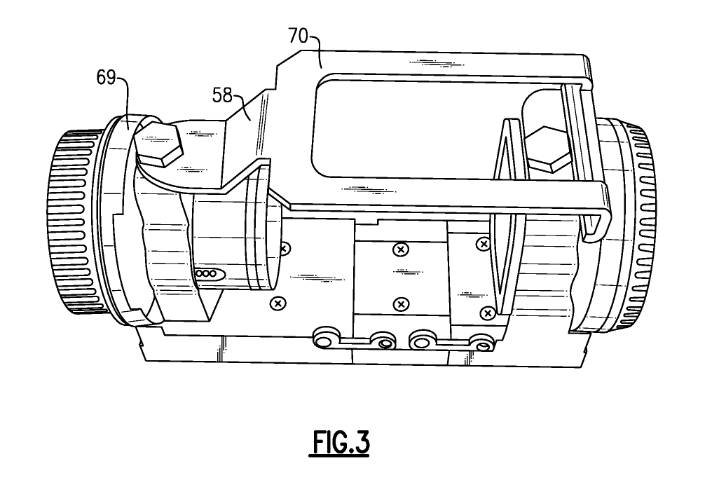

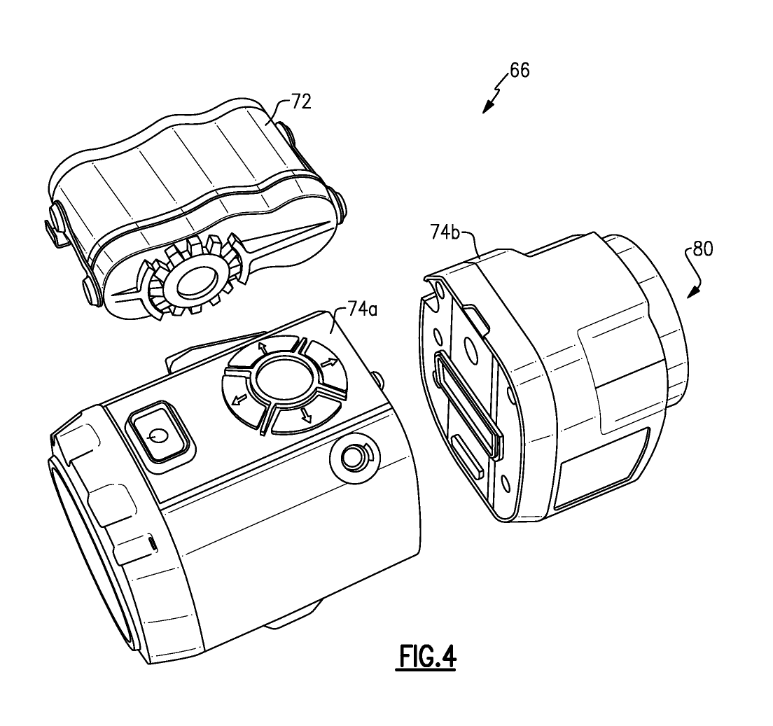

Referring to FIGS. 2 to 4, another example camera assembly 50 includes a camera body 54, a cradle 58, and a camera lens 62. The camera body 54 and the camera lens 62 are commercial off-the-shelf components. In one example, the camera body 14 is a Canon 5D camera.

A SWIR module 66 is selectively received within the cradle 58. The cradle 58 may include a lid 70 that is secured to other portions of the cradle 58 to secure the SWIR module 66 within the cradle 58.

The SWIR module 66 connects to the side of the cradle 58 interfacing with the camera lens 62 via a custom bayonet mount. The SWIR module 66 slides into the cradle 58 and is rotated a quarter turn to “click” the SWIR module 66 into an installed position within the cradle 58.

The SWIR module 66 is supported within the cradle 58 near the camera body 54 by a relay optic barrel 69 that holds the relay optic. The barrel 69 presses into a back of the SWIR module 66 to hold the SWIR module 66

The example SWIR module 66 can image light wavelengths from 0.9 to 1.7 micrometers, and thus can image light wavelengths below the standard short wave infrared range.

The example SWIR module 66 includes a battery pack 72 and a main body portion having a first section 74a and a second section 74b. The first section 74a and the second section 74b are axially aligned when received within the cradle 58. The battery pack 72 is secured to a radially outer surface of the first section 74a. The first section 74a houses a SWIR sensor, and the second section 74b houses a display. An eyepiece (not shown) can connect to an end 80 to allow for direct viewing of the SWIR imagery on the display within the second section 74b.

In some examples, the SWIR module 66 can be used as a stand-alone SWIR viewer. That is, when the SWIR module 66 is outside the cradle 58, SWIR imagery can be viewed on the display 80 of the SWIR module 66 without using the camera body 54 or the camera lens 62. The eyepiece would replace the camera body 54, as well as part of the cradle assembly 58 that would typically hold the relay optic and adapt the cradle assembly 58 to the camera body 54. When the camera body 54 is removed from the cradle assembly 58 and the camera lens 62 still attached, the eyepiece can be attached to the end 80.

The SWIR module 66 can include an optical relay that magnifies an image captured by the SWIR module 66 over a fixed distance between an organic light emitting diode display of the camera body 54 and a sensor of the camera body 54.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A camera assembly comprising:
a camera body;
a camera lens;
a cradle that communicates signals between the camera body and the camera lens; and
a short wave infrared sensor module selectively received within the cradle.

2. The camera assembly of claim 1, further comprising a display to display an image received by the short wave infrared sensor module.

3. The camera assembly of claim 2, wherein the camera body comprises the display.

4. The camera assembly of claim 3, wherein the display is a first display, and the short wave infrared sensor module comprises a second display to display an image received by the short wave infrared sensor module.

5. The camera assembly of claim 1, further comprising a relay optic within the short wave infrared sensor module.

6. The camera assembly of claim 1, wherein the cradle selectively receives other modules.

7. The camera assembly of claim 1, including an optical relay within the short wave infrared sensor module, the optical relay magnifying an image captured by the short wave infrared sensor module over a fixed distance between an organic light emitting diode display of the camera body and a sensor of the camera body.

8. The camera assembly of claim 1, wherein the short wave infrared sensor module communicates with camera body and the camera lens through the cradle.

9. The camera assembly of claim 1, wherein the camera body and the camera lens are commercial off-the-shelf components.

10. A method of short wave infrared sensor module imaging, comprising:
communicating signals from a camera body through a cradle to control a camera lens; and
selectively receiving a short wave infrared sensor module within the cradle.

11. The method of claim 10, further comprising displaying a short wave infrared sensor image on the short wave infrared sensor module.

12. The method of claim 10, further comprising displaying an image from the short wave infrared sensor module on the camera body.

13. The method of claim 10, further comprising the step of selectively replacing the short wave infrared sensor module within the cradle with another type of imaging module.

14. The method of claim 10, wherein the camera body and camera lens are commercial off-the-shelf components.
